(19) United States
(12) Patent Application Publication
(10) Pub. No.: US 2002/0142660 A1
(43) Pub. Date: Oct. 3, 2002

(54) Connector

(75) Inventor: Takashi Abe, Tokyo (JP)

Correspondence Address: SUGHRUE MION, PLLC, 2100 PENNSYLVANIA AVENUE, N.W., WASHINGTON, DC, 20037, US

(73) Assignee: NEC CORPORATION

(21) Appl. No.: 10/103,796

(22) Filed: Mar. 25, 2002

(30) Foreign Application Priority Data
Mar. 30, 2001 (JP) 2001-098946

(51) Int. Cl. H01R 24/00

(52) U.S. Cl. 439/631

(57) ABSTRACT

A connector according to the invention includes: a plurality of sockets into which a plurality of electronic parts are inserted, respectively; a coupling element which connects the sockets together; and a plurality of pins for electric connection provided in a limited area. Another connector of the invention includes: terminals provided in holes, wherein the holes are provided on the top, and wherein the electronic parts are inserted to the holes, respectively; pins provided in a limited area on the bottom; and a wiring network via which the terminals and the pins are connected. Another connector of the invention includes a bottom; pins provided near and along a first side of the bottom; at least one pin provided near and along a second side of the bottom; sockets into which electronic parts are inserted, respectively; and a coupling element that connects the sockets together.

### BACKGROUND OF THE INVENTION

The present invention relates to a connector, and more particularly, to a connector into which a plurality of electronic parts are inserted.

Conventionally, one electronic part was inserted into this type of connector. An example of such an electronic part is a Dual Inline Memory Module (DIMM).

Referring to FIG. 6, conventional connectors 900 are mounted on a printed circuit board 30. Each of the connectors 900 has one socket into which one DIMM 200 is inserted. Therefore, when mounting a plurality of DIMMs 200 on a printed circuit board 30 using the conventional connectors, a plurality of sets of the DIMM 200 and the connector 900 are mounted.

When mounting a plurality of DIMMs on the printed circuit board 30 using the conventional connectors described above, electric wiring between the DIMMs 200, each inserted into the connector 900, and electric wiring between the DIMM 200 and other electronic parts on the printed circuit board 30 are provided in an area under or around the plurality of connectors 900 on the circuit board 30. More specifically, in an area on the printed circuit board 30 where a plurality of DIMMs 200 are mounted such as the one shown in FIG. 6, wires 310, each of which connects one connector pin to another, and a wire 320, which is connected to a connector pin and a terminal of some other electronic part, are provided on the surface of, or inside, the printed circuit board 30. Thus, in the conventional art, the wires 310 and 320 occupy much space of the area on the printed circuit board 30 immediately under the plurality of DIMMs 200 and reduce the wiring space on the printed circuit board 30.

### SUMMARY OF THE INVENTION

It is an object of the present invention to provide a connector that allows a plurality of electronic parts to be mounted.

It is another object of the present invention to provide a connector that requires a less amount of wiring space on a board on which the connector is mounted.

According to one aspect of the present invention, a connector is provided which includes: a plurality of sockets into which a plurality of electronic parts are inserted, respectively; a coupling element which connects the sockets together; and a plurality of pins for electric connection provided in a limited area.

According to another aspect of the present invention, a connector is provided which includes: a plurality of terminals provided in a plurality of holes, wherein the holes are provided on the top, and wherein the electronic parts are inserted to the holes, respectively; a plurality of pins provided in a limited area on the bottom; and a wiring network via which the terminals and the pins are connected.

According to another aspect of the present invention, a connector is provided which includes: a bottom; a plurality of pins provided near and along a first side of the bottom; at least one pin provided near and along a second side of the bottom; a plurality of sockets into which a plurality of electronic parts are inserted, respectively; and a coupling element that connects the plurality of sockets together.

### BRIEF DESCRIPTION OF THE DRAWINGS

Other features and advantages of the invention will be made more apparent by the following detailed description and the accompanying drawings, wherein:

FIG. 1 is a perspective view of a connector of the present invention;

FIG. 2 is a cross sectional view taken on line A-A in FIG. FIG. 3 is another perspective view of the connector of the present invention;

FIG. 4 is a diagram showing the wiring of a coupling element 110 of the connector according to the present invention;

FIG. 5 is a cross sectional view of a coupling part of a connector in a second embodiment of the present invention; and

FIG. 6 is a diagram showing a conventional connector.

In the drawings, the same reference numerals represent the same structural elements.

### DETAILED DESCRIPTION OF THE PREFERRED EMBODIMENTS

A first embodiment of the present invention will be described in detail below.

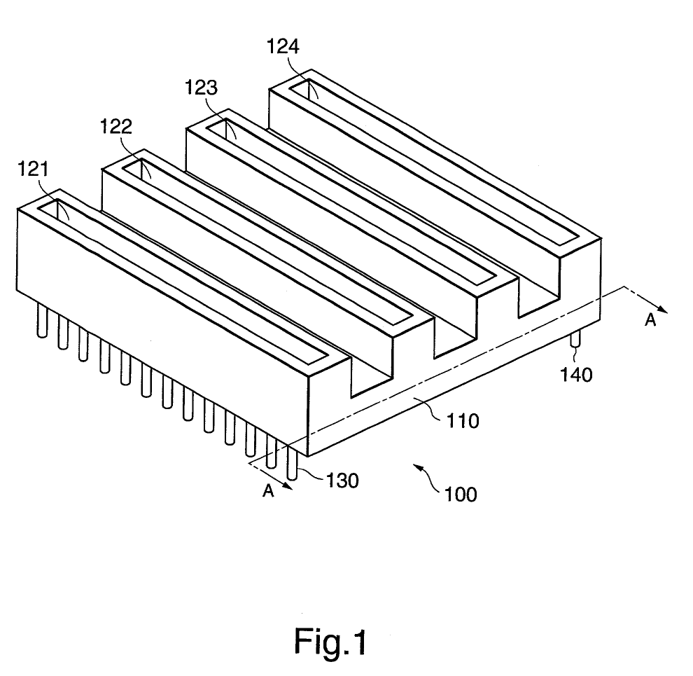

Referring to FIG. 1, a connector 100 according to the present invention comprises a coupling element 110, a plurality of sockets 121, 122, 123, and 124, a plurality of pins 130, and a plurality of mounting pins 140.

The coupling element 110 couples the plurality of sockets 121, 122, 123, and 124 into one connector. The coupling element 110 includes a plurality of wires.

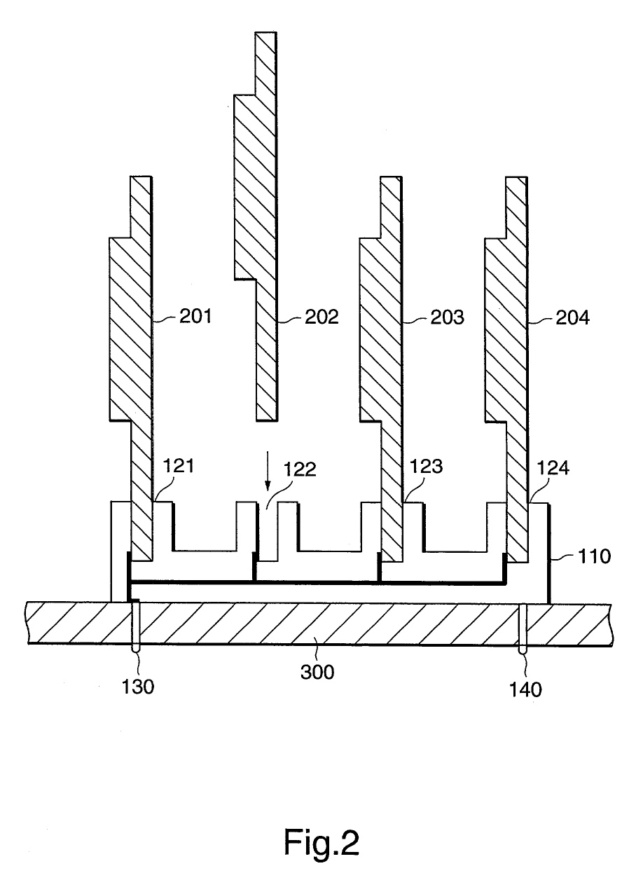

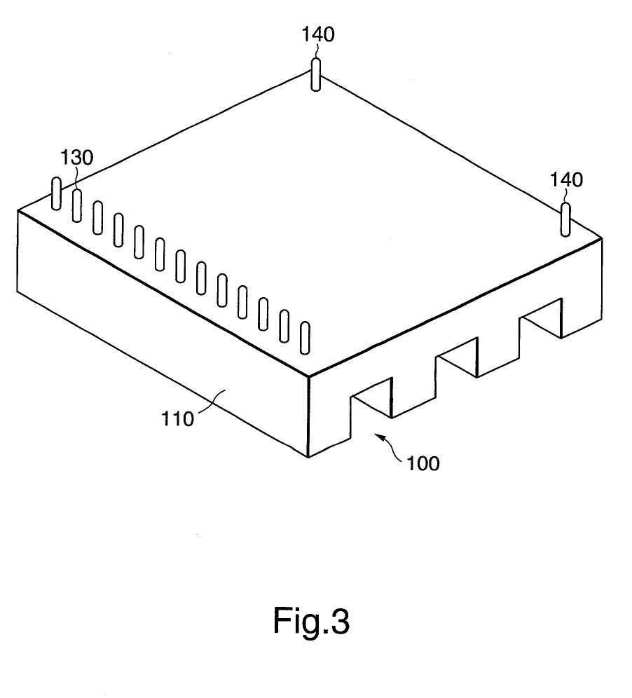

Referring to FIG. 2, the plurality of sockets 121, 122, 123, and 124 each have a corresponding electronic part inserted. The electronic parts are, for example, memory modules 201, 202, 203, and 204 such as a Dual Inline Memory Module (DIMM). The sockets 121, 122, 123, and 124 are provided on the top of the extended part on the coupling element 110. That is, the coupling element 110 has the sockets 121, 122, 123, and 124 thereon that are convex shaped extensions protruding above the surrounding area. The sockets 121, 122, 123, and 124 each accept one of the corresponding memory modules 201, 202, 203, and 204. The memory modules 201, 202, 203, and 204, which are inserted into the sockets 121, 122, 123, and 124, are guided by the sockets 121, 122, 123, and 124. The memory modules 201, 202, 203, and 204 are fully seated when their electrodes come into contact with the connector terminals in the coupling element 110.

Referring to FIGS. 1, 2, and 3, the plurality of pins 130 are provided on the bottom of the coupling element 110. The pins 130 are used to mount the connector 100 on the printed circuit board 300 and to electrically connect the wires on the printed circuit board 300 to the memory modules 201, 202, 203, and 204. The pins 130 are inserted into the corresponding holes on the printed circuit board 300. The plurality of pins 130 are arranged in a line on the bottom of the connector 100. The pins 130 are not provided in an area except an area along the one side of the bottom of the connector 100. In this embodiment, the row of the pins 130 is parallel with the long side of the sockets 121, 122, 123, and 124.

The mounting pins 140 are provided on the side of the bottom of the connector 100 opposite to the side along which the pins 130 are provided. The mounting pins 140 are used, not to electrically connect the memory modules 201, 202, 203, and 204 on the connector 100 to the printed circuit board 30, but to physically connect the connector 100 to the printed circuit board 300. In this embodiment, two mounting pins 140 are provided in the two corners on the bottom of the connector 100. Therefore, any member, including pin-shaped members, is not provided between the two mounting pins 140 on the bottom of the connector 100. In this embodiment, pin-shaped members are provided at both ends of the bottom of the connector 100, that is, an area along one side of the connector 100 and an area opposite to that side.

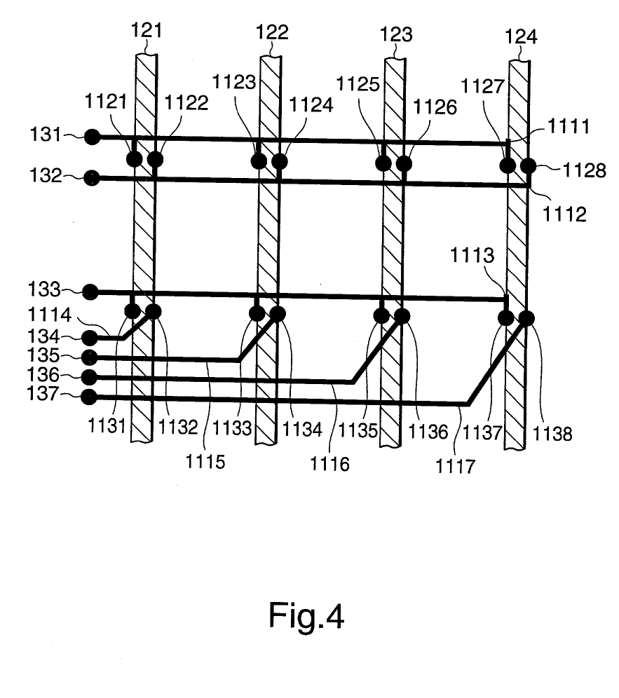

Referring to FIG. 4, the coupling element 110 comprises wires 1111, 1112, . . . , and 1117. The coupling element 110 comprises connector terminals 1121, 1122, 1123, 1124, 1125, 1126, 1127, 1128, 1131, 1132, 1133, 1134, 1135, 1136, 1137, and 1138. The pins 130 comprise pins 131, 132, . . . , and 137.

The connector terminals 1121, 1122, 1131, and 1132 are connected to the corresponding electrodes of the memory module 201 when the memory module 201 is inserted into the socket 121. The connector terminals 1123, 1124, 1133, and 1134 are connected to the corresponding electrodes of the memory module 202 when the memory module 202 is inserted into the socket 122. The connector terminals 1125, 1126, 1135, and 1136 are connected to the corresponding electrodes of the memory module 203 when the memory module 203 is inserted into the socket 123. The connector terminals 1127, 1128, 1137, and 1138 are connected to the corresponding electrodes of the memory module 204 when the memory module 204 is inserted into the socket 124.

The wire 1111 connects the connector terminals 1121, 1123, 1125, and 1127 together and connects them to the pin 131. The wire 1112 connects the connector terminals 1122, 1124, 1126, and 1128 together and connects them to the pin 132. The wire 1113 connects the connector terminals 1131, 1133, 1135, and 1137 together and connects them to the pin 133. In this way, the wires 1111, 1112, and 1113 connect together the connector terminals corresponding to the sockets 121, 122, 123, and 124.

The wire 1114 connects the connector terminal 1132 to the pin 134. The wire 1115 connects the connector terminal 1134 to the pin 135. The wire 1116 connects the connector terminal 1136 to the pin 136. The wire 1117 connects the connector terminal 1138 to the pin 137. In this way, the wires 1114, 1115, 1116, and 1117 each connect one connector terminal to one pin. The wires 1114, 1115, 1116, and 1117 each connect to one of the pins of a Large Scale Integration (LSI) circuit on the printed circuit board 300.

In this embodiment, the wires 1111, 1112, . . . , and 1117 are wiring cables. The wires 1111, 1112, . . . , and 1117 are constructed such that they have an impedance equal or close to that of the printed circuit board 300. For example, the impedance of the wires 1111, 1112, . . . , and 1117 is about 50-70 ohms that is the impedance of a standard printed circuit board.

As described above, the coupling element 110 of the connector according to the present invention has the plurality of sockets 121, 122, 123, and 124 and the wires that connect the electrodes of the memory modules 201, 202, 203, and 204, which are to be inserted into the sockets, to desired terminals. This construction allows a plurality of electronic parts to be mounted on the connector 100.

In addition, the coupling element 110 of the connector according to the present invention has the wires that connect a plurality of memory modules together and has the pins 130 provided only in a limited part of the bottom of the connector 100. This structure takes up less wiring space on the board 300.

Next, a second embodiment of the present invention will be described in detail. The second embodiment of the present invention differs from the first embodiment in that capacitive elements are provided on a coupling element 110. The other configuration is similar to that of the first embodiment.

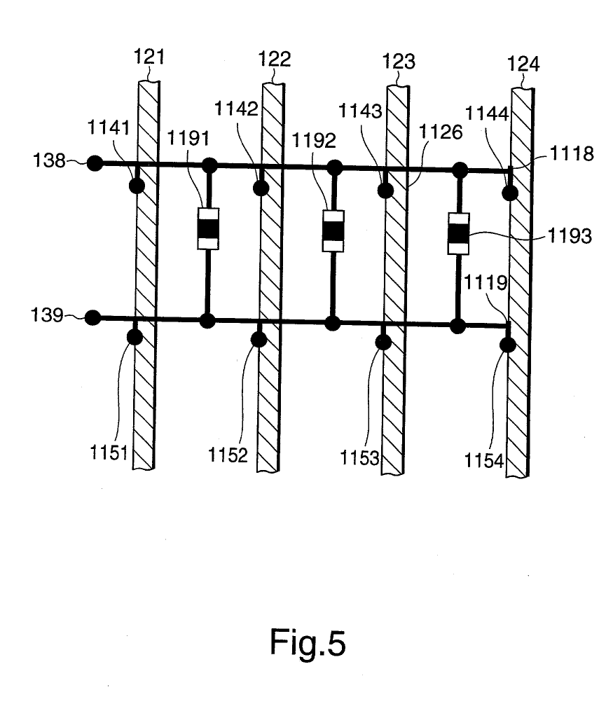

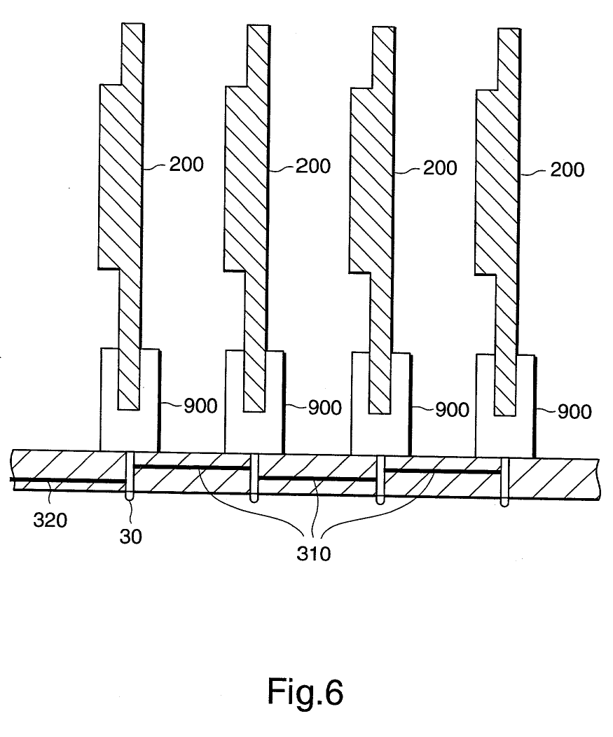

Referring to FIG. 5, the coupling element 110 comprises wires 1118 and 1119. The coupling element 110 comprises connector terminals 1141, 1142, 1143, 1144, 1151, 1152, 1153, and 1154. The coupling element 110 comprises capacitors 1191, 1192, and 1193. The wire 1118 is connected to the power supply pins of memory modules 201, 202, 203, and 204. The wire 1119 is connected to the ground (GND) pins of the memory modules 201, 202, 203, and 204.

The connector terminals 1141 and 1151 are connected to the corresponding electrodes of a memory module 201 when the memory module 201 is inserted into a socket 121. The connector terminals 1142 and 1152 are connected to the corresponding electrodes of a memory module 202 when the memory module 202 is inserted into a socket 122. The connector terminals 1143 and 1153 are connected to the corresponding electrodes of a memory module 203 when the memory module 203 is inserted into a socket 123. The connector terminals 1144 and 1154 are connected to the corresponding electrodes of a memory module 204 when the memory module 204 is inserted into a socket 124.

The wire 1118 connects the connector terminals 1141, 1142, 1143, and 1144 together and, at the same time, connects them to a pin 138. The pin 138 is connected to the power supply wire of a printed circuit board 300. The wire 1119 connects the connector terminals 1151, 1152, 1153, and 1154 together and, at the same time, connects them to a pin 139. The pin 139 is connected to the GND wire of the printed circuit board 300.

The wire 1118 and the wire 1119 are connected via the capacitors 1191, 1192, and 1193.

Next, the mode of the present invention will be described.

Although the wires on the coupling element 110 are wiring cables in the above embodiments, the coupling element 110 may include a printed circuit board and the wires may be provided on the printed circuit board. In this case, the wires are on or inside the printed circuit board. This structure optimizes the distance between the wires and the ground and the wiring width, making it easier to make the impedance of the wires equal or close to that of the board 300.

Although electronic parts to be inserted into the sockets are memory modules in the embodiments, the present invention is not limited to memory modules but may be applied to other electronic parts. For example, instead of a memory module, a Peripheral Components Interconnect (PCI) board maybe inserted.

In addition, although the areas where the sockets 121, 122, 123, and 124 are formed on the coupling element 110 are convex shaped extensions that protrude above the surrounding area in the embodiments, the coupling element 110 may be constructed as a plane. In this case, the top of the coupling element 110 is virtually flat.

Although the row of the pins 130 is parallel to the long side of the sockets 121, 122, 123, and 124 in the embodiments, the row of the pins 130 may be constructed in the direction at right angles to the long side of the sockets 121, 122, 123, and 124. In this case, the mounting pins 140 are provided on the side opposite to the row of the pins 130.

Although one row of pins 130 is provided and the mounting pins 140 are not used for electrical connection in the embodiments, the mounting pins 140 may be used for electrical connection. In this case, the mounting pins 140 are connected, as necessary, to the wires in the coupling element 110.

Although one row of the pins 130 is provided in the embodiments, a row of a plurality of pins which is similar to the row of the pins 130 and whose pins are connected to the wires of the coupling element 110 may be provided on the side where the mounting pins 140 are provided. That is, a row of pins is provided on a pair of opposing sides on the bottom of the connector 100.

Although two mounting pins 140 are provided in the above embodiments, only one pin may be provided. Alternatively, three or more mounting pins 140 may also be provided.

As described above, the connector according to the present invention has a plurality of sockets provided on the coupling part and has the wires that connect the electrodes of memory modules, which are inserted into the sockets, to the desired terminals. Because of this structure, the connector according to the present invention allows a plurality of electronic parts to be mounted.

In addition, the coupling part of the connector according to the present invention has wires that connect a plurality of memory modules together and has the pins provided only in a limited area on the bottom of the connector, thus requiring a less mount of wiring space on the board.

While this invention has been described in conjunction with the preferred embodiments described above, it will now be possible for those skilled in the art to put this invention into practice in various other manners.

What is claimed is:

1. A connector comprising:
a plurality of sockets into which a plurality of electronic parts are inserted, respectively;
a coupling element which connects said sockets together; and
a plurality of pins for electric connection provided in a limited area.

2. The connector as claimed in claim 1, wherein said coupling element includes wires which connect the plurality of electronic parts inserted into said plurality of sockets.

3. The connector as claimed in claim 2, wherein said wires have an impedance which is equal or close to an impedance of a first board on which said connector is mounted.

4. The connector as claimed in claim 2, wherein said coupling element includes a second board on which said wires are provided.

5. The connector as claimed in claim 4, wherein said second board has an impedance which is equal or close to an impedance of a first board on which said connector is mounted.

6. The connector as claimed in claim 1, wherein said coupling element includes a capacitive element.

7. The connector as claimed in claim 1, further comprising mounting pin which is provided on a bottom of said connector and which is not used for electric connection.

8. The connector as claimed in claim 1, wherein said plurality of pins for electric connection are arranged in a row.

9. The connector as claimed in claim 1, wherein said limited area includes a part of peripheral area.

10. A connector comprising:
a plurality of terminals provided in a plurality of holes, wherein said holes are provided on the top, and wherein said electronic parts are inserted to said holes, respectively;
a plurality of pins provided in a limited area on the bottom; and
a wiring network via which said terminals and said pins are connected.

11. The connector as claimed in claim 10, wherein said wiring network has an impedance which is equal or close to an impedance of a first board on which said connector is mounted.

12. The connector as claimed in claim 10, further comprising a second board on which said wiring network is formed.

13. The connector as claimed in claim 12, wherein said second board has an impedance which is equal or close to an impedance of a first board on which said connector is mounted.

14. The connector as claimed in claim 10, wherein said wiring network includes a capacitive element.

15. The connector as claimed in claim 10, further comprising mounting pin which is provided on the bottom of said connector and which is not used for electric connection.

16. The connector as claimed in claim 10, wherein said pins for electric connection are arranged in a row.

17. The connector as claimed in claim 10, wherein said limited area includes a part of peripheral area.

18. A connector comprising:
a bottom;
a plurality of pins provided near and along a first side of the bottom;
at least one pin provided near and along a second side of the bottom;
a plurality of sockets into which a plurality of electronic parts are inserted, respectively; and
a coupling element that connects the plurality of sockets together.
